(19) United States
(12) Patent Application Publication
(10) Pub. No.: US 2021/0409132 A1
(43) Pub. Date: Dec. 30, 2021

(54) APPARATUS FOR IDENTIFYING LINE OF SIGHT AND NON-LINE OF SIGHT

(71) Applicant: MITSUBISHI ELECTRIC CORPORATION, Tokyo (JP)

(72) Inventors: Arnaud BOUTTIER, Rennes (FR); Guillaume VERCASSON, Rennes (FR); Xavier NOURISSON, Rennes (FR)

(73) Assignee: MITSUBISHI ELECTRIC CORPORATION, Tokyo (JP)

(21) Appl. No.: 16/614,240

(22) PCT Filed: Jun. 4, 2018
(86) PCT No.: PCT/JP2018/022131

§ 371 Date: Nov. 15, 2019

(30) Foreign Application Priority Data
Jul. 6, 2017 (EP) 17305872.8

(51) Int. Cl. H04B 17/391; G01S 5/02; H04L 25/02

(52) U.S. Cl. CPC H04B 17/391; G01S 5/0215; H04L 25/024; H04W 4/40; H04L 25/0206; H04L 25/0222; H04L 25/0212

(57) ABSTRACT

Embodiments include apparatuses and methods of identifying line of sight, LOS, and non-line of sight, NLOS, conditions in a multipath channel of a vehicular communication system. It is proposed to equip the receiving node with a dual antenna receiver. Then the proposed solution uses the first cluster of multipath components of channel estimates measured on the two antennas to derive the LOS/NLOS channel conditions based on hypothesis testing.

### TECHNICAL FIELD

This invention relates to an apparatus and a method of identifying line of sight, LOS, and non-line of sight, NLOS, conditions in a multipath channel of a vehicular communication system.

### BACKGROUND ART

Location-aware wireless applications are in need of accurate localization methods. A typical application is the localization of a vehicle from one or several base stations in a vehicular cooperative communication networks such a Vehicle-to-everything (V2X) communication systems.

One challenge for localization system is to successfully mitigate non-line of sight (NLOS) effects by identifying whether the channel is a line of sight (LOS) channel or a NLOS channel. Indeed, the delay estimation error caused by a NLOS channel is the most serious one of those factors that affects the estimation accuracy of localization. The LOS channel can be understood as a transmitter in line of sight with a receiver while a NLOS channel can be understood as a transmitter in non-line of sight with a receiver.

In vehicular communication systems, known localization methods use triangulation techniques which are based on measurements of received signal strengths (RSS), time of arrival (ToA), time difference of arrival (TDoA) or more generally angles of arrival (AoA) between two or more nodes. However, it has been shown that NLOS propagation increases RSS, ToA and TDoA measurements errors and thus generates large localization error. To avoid the impact of NLOS on localization performance, a node should identify NLOS channel conditions.

Therefore, there is a need for discriminating between LOS and NLOS channel conditions to improve localization accuracy.

### SUMMARY OF INVENTION

The present invention provides an apparatus and a method of identifying line of sight, LOS, and non-line of sight, NLOS, conditions in a multipath channel of a vehicular communication system, as described in the accompanying claims. Specific embodiments of the invention are set forth in the dependent claims. These and other aspects of the invention will be apparent from an elucidated with reference to the embodiments described hereinafter.

Further details, aspects and embodiments of the proposed solution will be described, by way of example only, with reference to the drawings. In the drawings, like or similar reference numbers are used to identify like or functionally similar elements. Elements in the figures are illustrated for simplicity and clarity and have not necessarily been drawn to scale.

### BRIEF DESCRIPTION OF THE DRAWINGS

FIG. 1 is an exemplary vehicular communication system.

FIG. 2 is a block diagram illustrating an apparatus in accordance with embodiments of the subject application.

FIG. 3 is a diagram of an exemplary channel impulse response estimate.

FIG. 4 is a diagram of an exemplary best-fit curve.

FIG. 5 is a flow chart of a method in accordance with an embodiment of the subject application.

### DESCRIPTION OF EMBODIMENTS

The general context of the invention is the detection of the line of sight (LOS) and non-line of sight (NLOS) conditions of the radio channel between two nodes of a vehicular communication system, where one node receives at random times radio packets transmitted by another node. Further, it is needed to perform the detection solely using the received radio signal without having any prior knowledge on the surrounding environment.

It is proposed to equip the receiving node with a dual antenna receiver. Then the proposed solution uses the first cluster of multipath components of channel estimates measured on the two antennas to derive the LOS/NLOS channel conditions based on hypothesis testing.

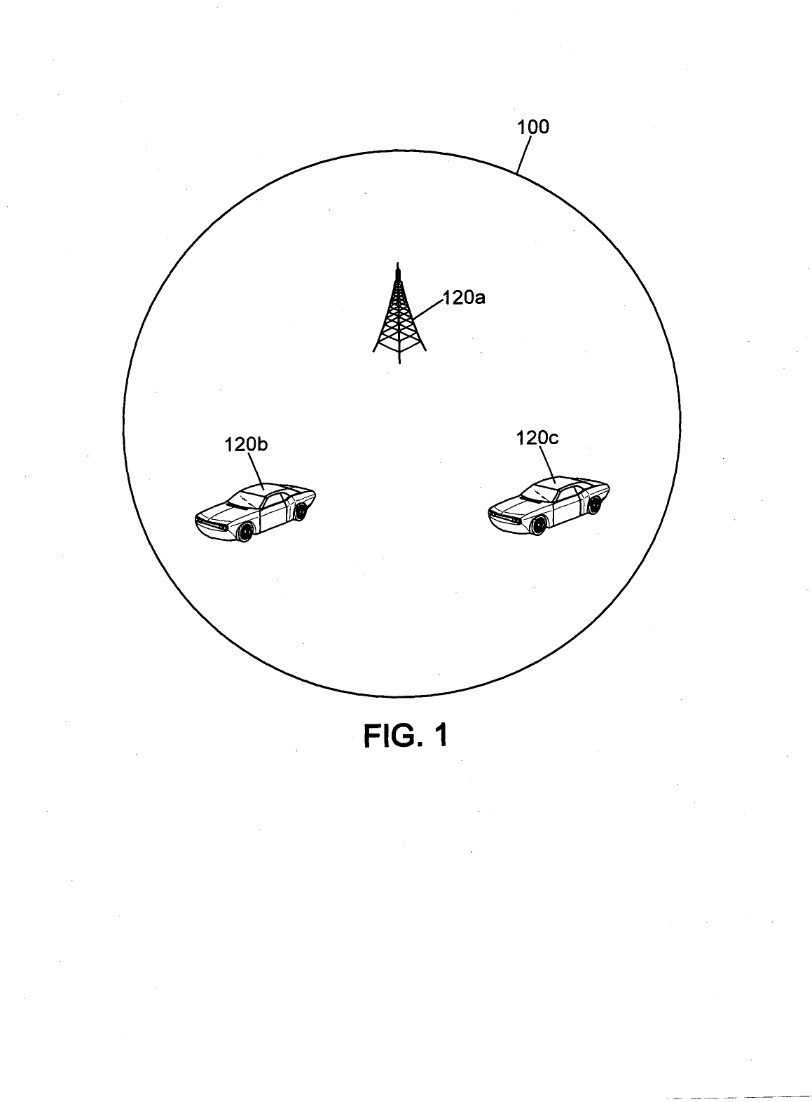

FIG. 1 shows an exemplary vehicular communication system 100. Vehicular communication system 100 may be a Vehicular Ad Hoc Network (VANET) or a Vehicle-to-everything communication network (V2X). Vehicular communication system 100 comprises a plurality of nodes such as base station 120a and vehicles 120b and 120c. Nodes 120a, 120b and 120c are configured to be in relative motion with respect to each other. In an example, node 120a has a fixed position while nodes 120b and 120c are in motion with respect to node 120a. In another example, nodes 120b and 120c are in relative motion with respect to each other. In yet another example, nodes 120a and 120b have a fixed position while node 120c is in motion.

Further in FIG. 1, each of nodes 120a, 120b and 120c can operate either as a transmitting node or as a receiving node. In the following description, node 120b is considered as a transmitting node and comprises a transmitter while node 120c is considered as a receiving node and comprises a receiver. However, other configurations are allowed without departing from the scope of the invention. For example, node 120c may be considered as a transmitting node and node 120a may be considered as a receiving node. In the example of FIG. 1, transmitting node 120b is configured to transmit a plurality of non-periodic signals. Receiving node 120c is configured to receive the plurality of non-periodic signals. One should understand that a non-periodic signal is a signal that cannot be divided into fixed time periods of the same duration. Non-periodic signals are usually referred to as asynchronous or non-slotted signals.

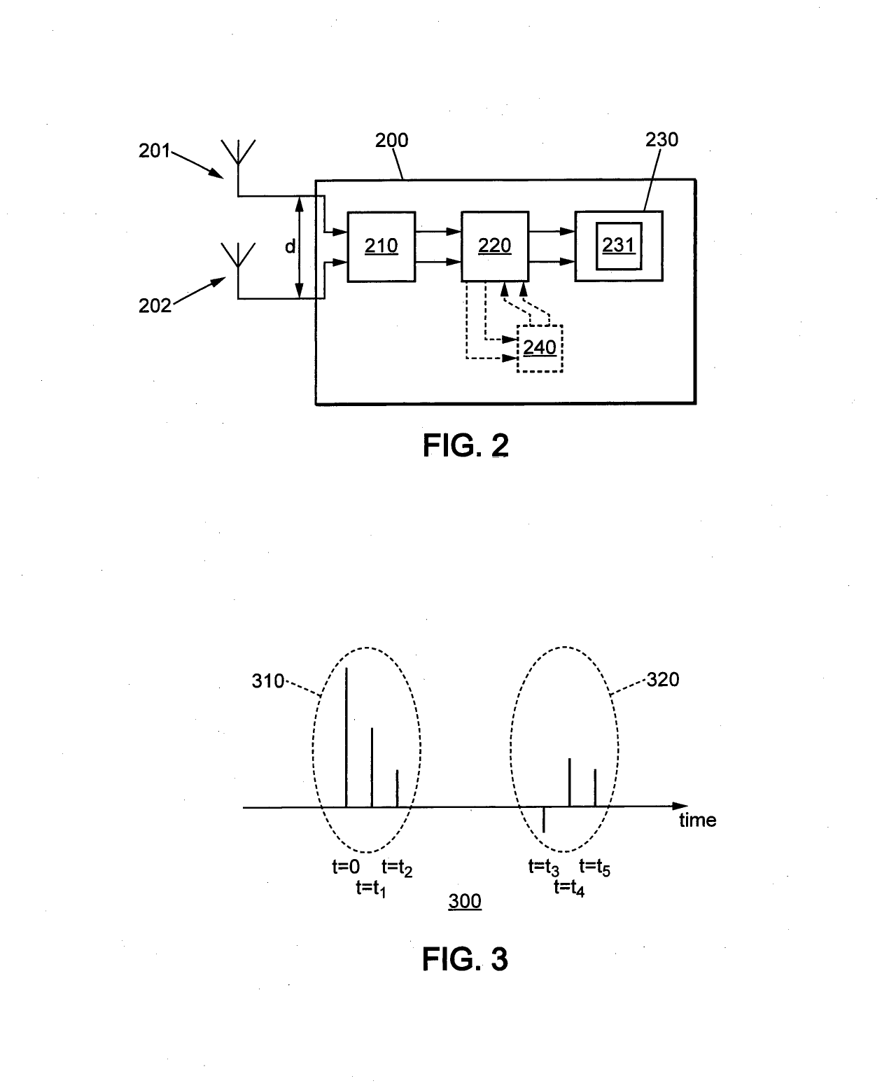

FIG. 2 illustrates an apparatus 200 for identifying line of sight (LOS) and non-line of sight (NLOS) conditions in a multipath channel of vehicular communication system 100. Apparatus 200 may be included in a receiver (not shown) of receiving node 120c. In FIG. 2, apparatus 200 comprises an array of antennas. The array of antennas comprises a first antenna 201 and a second antenna 202 which are separated by a separation distance d and configured to be mutually synchronized. In an example, first antenna 201 and second antenna 202 are installed with fixed relative position and are so separated to maintain independent channels. In an embodiment, first antenna 201 and second antenna 202 are separated by more than half a wavelength. Further, the receiver operating on first antenna 201 and second antenna 202 shares the same local oscillator (not shown). Therefore, first antenna 201 and second antenna 202 are said to be synchronized. Moreover, gain and at least frequency synchronization operations are jointly performed on the signals received at first and second antennas 201, 202.

Further in FIG. 2, apparatus 200 comprises at least, a channel estimator 210, a channel processor 220 and a statistical hypothesis test unit 230 which are operably coupled together.

Channel estimator 210 is configured for estimating, at each of the plurality of time points, first and second channel estimates respectively associated with each non-periodic signal received on first and second antennas 201, 202. Each of the first and second channel estimates comprises multipath components arranged in clusters. It is assumed that the channel estimates are sampled at a rate slower than the inverse of the channel coherence time in order to obtain uncorrelated Gaussian samples. It is further considered that the propagation environment around receiving node 120c can be described as a multipath environment where power is received through diffractions and reflections from objects in the surroundings. In that case, it is known that receiving node 120c may receive multipath components, that is, multiple instances of the same signal at different times, i.e. with different delays, because different portions of the signal are reflected from various objects, such as buildings, moving vehicles or landscape details. In the following description, multipath components with approximately the same directions and delays are considered as clusters. Therefore, each of the clusters corresponds to the signal received from one scatterer. FIG. 3 shows an exemplary channel impulse response estimate 300 comprising two clusters 310, 320 of multipath components.

In the example of FIG. 2, channel processor 220 is configured for identifying a cluster in each of the first and second channel estimates, wherein said identified cluster is received earlier in time than the remaining clusters. In the following description, said identified cluster would be considered as the “first” cluster. In an embodiment, channel processor 220 estimates a time of arrival of the clusters for determining the first cluster.

Further, channel processor 220 is also configured for generating a complex representation of each of the identified clusters, thereby generating first and second complex signals. The complex representation comprises a complex amplitude component and one or more complex phase components. In an example, channel processor 220 comprises a conventional quadrature detector (not shown)). The conventional quadrature detector is operably coupled to each of first and second antennas 201, 202 and forms respective complex numbers from the signals received at first and second antennas 201, 202. A real part of each complex number shows the in-phase components of the channel while an imaginary part of each complex number shows the quadrature components of the channel. The conventional quadrature detector also determines the phase components of the signals received at each of first and second antennas 201, 202. Finally, channel processor 220 generates the first and second complex signals based on the complex numbers and the phase components.

It has been shown that if the number of scatterers of a multipath channel is large enough, the amplitude of the first cluster can be modelled as a zero mean circularly-symmetric random complex Gaussian process irrespective of the distribution of the individual multipath components. It has been further shown that when the multipath channel also includes a component path which is stronger than the other paths, said dominant path being usually known as the LOS component or the deterministic component of the Rice model, the amplitude of the first cluster can be modelled as a circularly-symmetric random complex Gaussian process with an complex mean of A×e^{-jγ} where A is a real number and γ exhibits the complex character of A.

In an example, based on the foregoing, the first and second complex signals associated with the first clusters can be mathematically represented according to following relation (1):

$$\{ \begin{matrix}{x}_{rx 1} = A \times {e}^{- j γ} \times {e}^{- j φ} + {b}_{rx 1} \\ {x}_{rx 2} = A \times {e}^{- j γ} \times {e}^{- j φ} \times {e}^{- j π \times \frac{d}{λ} \times cos θ} + {b}_{rx 2}\end{matrix}$$

where xᵣₓ₁ is the first complex signal, xᵣₓ₂ is the second complex signal, φ is a random phase component which has been found to be present on first and second antennas 201, 202, θ is a bisector angle of arrival of the received signal on the array of antennas 201, 202 at a perpendicular bisector of a straight line connecting first and second antennas 201, 202, d is a separation distance between first and second antennas 201, 202, λ is a wavelength of vehicular communication system 100, bᵣₓ₁ is a noise component present on first antenna 201, bᵣₓ₂ is a noise component present on the second antenna. One should note that the noise components bᵣₓ₁ and bᵣₓ₂ may comprise Rayleigh noise components of the cluster amplitude and/or Gaussian noise components resulting from the noisy estimate of the channel response.

As can be noticed from relation (1), the first cluster complex amplitude is affected by a random phase φ mainly resulting from the Doppler shift and the frequency synchronization errors due to the non-periodic nature of the received signals. Further, it is also noted that the random phase φ is present on both first and second complex signals. Therefore, one can take advantage of the foregoing and get rid of the random phase φ.

Returning back to FIG. 2, channel processor 220 is configured for processing the first complex signal so as to remove phase components which are in common with phase components associated with the second complex signal, thereby creating a processed first complex signal.

In an embodiment, channel processor 220 creates the processed first complex signal according to following relation (2):

x̅ᵣₓ₁=xᵣₓ₁×e^{-j×arg(x}^{ᵣₓ₂}⁾

where x̅ᵣₓ₁ is the processed first complex signal, xᵣₓ₁ is the first complex signal, xᵣₓ₂ is the second complex signal and arg(·) represents the complex argument of a given complex number.

In another embodiment, channel processor 220 processes the second complex signal so as to remove phase components which are in common with phase components associated with the first complex signal, thereby creating a processed second complex signal. Further, channel processor 220 creates the processed second complex signal according to following relation (3):

x̅ᵣₓ₂=xᵣₓ₂×e^{-j×arg(x}^{ᵣₓ₁}⁾

where x̅ᵣₓ₂ is the processed second complex signal, xᵣₓ₁ is the first complex signal, xᵣₓ₂ is the second complex signal and arg(·) represents the complex argument of a given complex number.

In yet another embodiment, channel processor 220 processes the first and second complex signals so as to remove phase components which are in common in first and second complex signals, thereby creating a processed combined complex signal. Further, channel processor 220 creates the processed combined complex signal according to following relation (4):

x̅ᵣₓ=½×(xᵣₓ₁×e^{-j×arg(x}^{ᵣₓ₂}⁾+xᵣₓ₂*×e^{j×arg(x}^{ᵣₓ₁}⁾

where x̅ᵣₓ is the processed combined complex signal, xᵣₓ₁ is the first complex signal, xᵣₓ₂* is the complex conjugate of the second complex signal and arg( ) represents the complex argument of a given complex number.

Further, it has been noted that when the multipath channel is in NLOS conditions, the first cluster coefficients correspond to a zero-mean complex Gaussian process while in LOS conditions, the first cluster coefficients correspond to a complex Gaussian process with a complex mean (see above, A×e^{-jγ}). Therefore, it has been concluded that the identification of LOS/NLOS channel conditions can be based on the detection of an unknown complex constant level in a Gaussian noise, that is, the fast fading and additive noise due to channel estimation.

It has been found that hypothesis testing could be used to perform that identification. In that case, the phenomenon that is tested is whether or not a transmitter and a receiver are in LOS conditions. The foregoing can be reformulated as two hypotheses:
H0=NLOS conditions hypothesis, and
H1=LOS conditions hypothesis.

Based on the foregoing, it is proposed to perform a hypothesis testing based on a coherent generalized likelihood ratio test, GRLT, algorithm that operates on the normalized mean of a set of observations.

Referring back to FIG. 2, statistical hypothesis test unit 230 is configured for applying a coherent GRLT algorithm to the processed complex signals (i.e., the processed first complex signal, the processed second complex signal and/or the processed combined complex signal) to identify LOS or NLOS conditions.

In an embodiment, statistical hypothesis test unit 230 applies the coherent GRLT algorithm according to following relation (5):

$$\frac{{\vert \frac{1}{N} \times {\sum }_{k = 0}^{N - 1} {x}_{k} \vert}^{2}}{\frac{1}{N} \times {\sum }_{k = 0}^{N - 1} {\vert {x}_{k} \vert}^{2}} \begin{matrix}{<}^{H 0} \\ {>}_{H 1}\end{matrix} σ$$

where N is the number of received non-periodic signals, xₖ is the processed complex signals, H0 is the NLOS hypothesis, H1 is the LOS hypothesis and σ is a predetermined threshold. In an example, the threshold value σ is obtained from the determination of a receiver operating characteristic (ROC) curve, where the ROC curve is a plot of the probability of detection (Pd) vs. the probability of false alarm (Pfa) for a given signal-to-noise ratio (SNR). The probability of detection (Pd) is the probability of saying that “1” is true given that event “1” occurred. The probability of false alarm (Pfa) is the probability of saying that “1” is true given that the “0” event occurred. In the invention, for example, the “1” event indicates LOS conditions, and the “0” event indicates NLOS conditions. In another example, the “1” event indicates NLOS conditions, and the “0” event indicates LOS conditions.

The hypothesis criterion of relation (5) is defined to get rid of the random phase φ component which varies from processed complex signals to processed complex signals over the considered measurement window. The idea is to average the first cluster amplitude in real and imaginary parts. In the complex plan, this could be illustrated as the superposition of vectors where each vector is defined by the real/imaginary amplitude of each processed complex signals. In that case, the numerator of the hypothesis criterion of relation (5) which takes the modulus of the amplitude mean of the processed complex signals, corresponds in the complex plan, to length of the superposition of said vectors. Further, it is assumed that the bisector angle of arrival θ is constant over the considered measurement window.

In another embodiment, statistical hypothesis test unit 230 comprises a memory unit 231 for storing the processed complex signals wherein memory unit 231 is configured to discard a predetermined number of processed complex signals after the applying of the GRLT algorithm. In an embodiment, memory unit 231 is a first-in-first-out (FIFO) memory which is configured to store a first predetermined number of processed complex signals at a time and discard a second predetermined number of processed complex signals before storing new processed complex signals. In an example, the first and second predetermined numbers have different values. For instance, the first predetermined number is equal to ten and the second predetermined number is equal to two. In that case, ever since two new processed complex signals are to be stored on memory unit 231, then the two oldest previously stored processed complex signals are discarded from memory unit 231. In another example, the first and second predetermined numbers have the same value. For instance, the first and second predetermined numbers are both equal to ten. In that case, ever since ten new processed complex signals are to be stored on memory unit 231, then all the previously stored processed complex signals are discarded from memory unit 231.

In the context of vehicular communications such as in vehicular communication system 100, it often occurs that the bisector angle of arrival θ experienced on the antenna array 201, 202 varies in time according to the motion of at least one of nodes 120b and 120c. Hence, each received non-periodic signal may have different bisector angle of arrival θ as nodes 120b and 120c are configured to be in motion relatively to each other. This variation may have a dramatic impact on the performance of the coherent GRLT algorithm. Indeed, the numerator of coherent GRLT algorithm as shown in relation (5) defines a sum of complex amplitudes which may suffer from a varying phase due to a variation of the bisector angle of arrival θ.

However, due to physical constraints, such as the angular speed of nodes 120b and 120c with reference to the speed being rather small, it has been shown that the bisector angle of arrival θ experienced on the array of antennas 201, 202 slowly changes in time over the measurement window (N samples), with typical duration of a few hundreds of milliseconds. It would be advantageous to compensate for the variation of the angle of arrival θ in the processed complex signals prior applying the GRLT algorithm.

A possible solution need to take into consideration that non-periodic signals are received by node 120c, sporadically, at a plurality of time points. Therefore, it is proposed to perform a regression analysis on the processed complex signals and the plurality of time points to find a “best fit” regression curve describing the bisector angle of arrival θ variations of the processed complex signals as a function of the plurality of time points. It is recalled that regression analysis also known as curve fitting is a statistical technic used to determine the “best fit” line or curve for a series of data points. Finally, after obtaining the “best fit” line or curve associated with processed complex signals as a function of the plurality of time points, it is proposed to compensate for these variations by rectifying the processed complex signals based on the variation of the bisector angle of arrival θ obtained from applying the plurality of time points to “best fit” line or curve. In an example, the regression analysis is performed on the phase component extracted from the processed complex signals. In that example, the “best fit” line or curve is then applied to the plurality of time points so as to obtain the phase variation resulting from the variation of the bisector angle of arrival θ. Then, the phase variation is used for compensating the phase component extracted from the processed complex signals. Finally, the compensated phase components are reintroduced into the processed complex signals before applying the GRLT algorithm. In another example, the regression analysis is performed separately on real and imaginary parts of the processed complex signals. Then, the phase to be used for compensating the original samples is estimated as the phase of the fitted pairs (I/Q) at the plurality of time points.

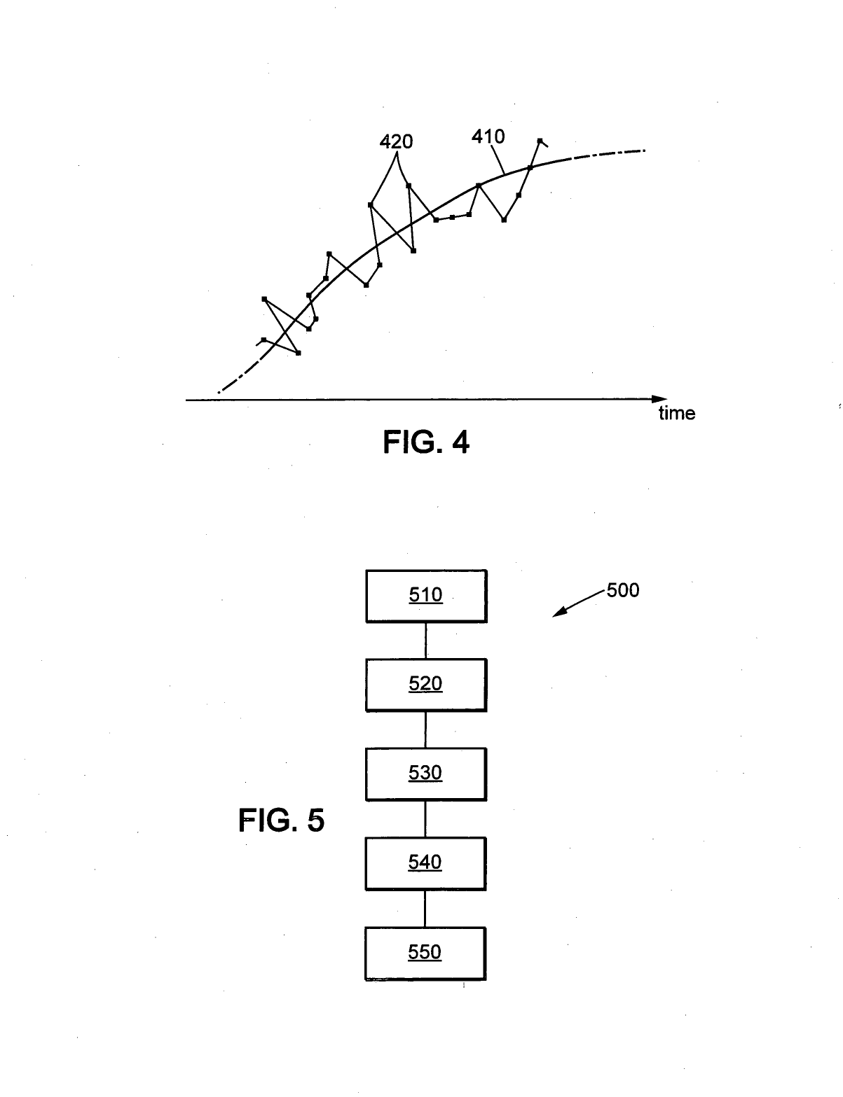

Referring again to FIG. 2, apparatus 200 further comprises a curve fitter 240. Curve fitter 240 is configured for applying a curve fitting algorithm to the processed complex signals (i.e., the processed first complex signal, the processed second complex signal and/or the processed combined complex signal), thereby generating a best-fit curve defining a variation of the phase component of the processed complex signals over time. For example, one can consider conventional curve fitting algorithms such as those based on a least-squares algorithms, weighted least-squares algorithms, robust least-squares algorithms, non-linear least-squares algorithms and spline algorithms. FIG. 4 illustrates an exemplary best fit polynomial curve 410 obtained from on a plurality of processed complex signals 420. Further, channel processor 220 is further configured for estimating phase compensated processed complex signals from the best-fit curve based on the plurality of time points. Finally, statistical hypothesis test unit 230 is further configured for applying the coherent GRLT algorithm to the phase compensated processed complex signals.

A receiver adapted for vehicular communication 100 and which includes apparatus 200 is also claimed.

Further, as shown in FIG. 5, embodiments of the proposed solution may also be implemented in a method 500 for identifying line of sight LOS and NLOS conditions in a multipath channel of vehicular communication 100 as already described above. Such method may include:
at S510, estimating, at each of the plurality of time points, first and second channel estimates respectively associated with each non-periodic signal received on the first and second antennas, each of the first and second channel estimates having multipath components arranged in clusters,
at S520, identifying a cluster of multipath components in each of the first and second channel estimates, wherein said identified cluster is received earlier in time than the remaining clusters,
at S530, generating a complex representation of each of the identified clusters comprising a complex amplitude component and one or more complex phase components, thereby generating first and second complex signals,
at S540, processing the first complex signal so as to remove phase components which are in common with phase components associated with the second complex signal, thereby creating a processed first complex signal,
at S550, applying a coherent generalized likelihood ratio test, GRLT, algorithm to the processed complex signals to identify LOS or NLOS conditions

In embodiments of the method, the identifying comprises estimating a time of arrival of the clusters.

In one embodiment of the method, the processing comprises creating the processed first complex signal according to following relation,

x̅ᵣₓ₁=xᵣₓ₁×e^{-j×arg(x}^{ᵣₓ₂}⁾

where x̅ᵣₓ₁ is the processed first complex signal, xᵣₓ₁ is the first complex signal and xᵣₓ₂ is the second complex signal.

In alternative embodiments of the method, the processing comprises:
processing the second complex signal so as to remove phase components which are in common with phase components associated with the first complex signal, thereby creating a processed second complex signal, and
creating the processed second complex signal according to following relation,

x̅ᵣₓ₂=xᵣₓ₂×e^{-j×arg(x}^{ᵣₓ₁}⁾

where x̅ᵣₓ₂ is the processed second complex signal, xᵣₓ₁ is the first complex signal and xᵣₓ₂ is the second complex signal.

In another embodiment of the method, the processing comprises:
processing first and second complex signals so as to remove phase components which are in common in first and second complex signals, thereby creating a processed combined complex signal, and
creating the processed combined complex signal according to following relation,

x̅ᵣₓ=½×(xᵣₓ₁×e^{-j×arg(x}^{ᵣₓ₂}⁾+xᵣₓ₂*×e^{j×arg(x}^{ᵣₓ₁}⁾

where x̅ᵣₓ is the processed combined complex signal, xᵣₓ₁ is the first complex signal and xᵣₓ₂* is the complex conjugate of the second complex signal.

In embodiments of the method, the coherent GRLT algorithm is determined according to following relation,

$$\frac{{\vert \frac{1}{N} \times {\sum }_{k = 0}^{N - 1} {x}_{k} \vert}^{2}}{\frac{1}{N} \times {\sum }_{k = 0}^{N - 1} {\vert {x}_{k} \vert}^{2}} \begin{matrix}{<}^{H 0} \\ {>}_{H 1}\end{matrix} σ$$

where N is the number of received non-periodic signals, xₖ is the processed complex signal, H0 is the NLOS hypothesis, H1 is the LOS hypothesis and a is a predetermined threshold.

In other embodiments of the method, it is further included, discarding a predetermined number of processed complex signals after the applying of GRLT algorithm.

In one embodiment of the method, it is further included:
applying a curve fitting algorithm to the processed complex signals, thereby generating a best-fit curve defining a variation of the phase component of the processed complex signals over time,
estimating phase compensated processed complex signals from the best-fit curve based on the plurality of time points, and
applying the coherent GRLT to the phase compensated processed complex signals.

The above-proposed method may also be performed by a computer program embodied in a non-transitory computer readable storage medium.

In the foregoing specification, the proposed solution has been described regarding specific examples of embodiments of the proposed solution. It will, however, be evident that various modifications and changes may be made therein without departing from the broader scope of the proposed solution as set forth in the appended claims.

1. A apparatus for identifying line of sight, LOS, and non-line of sight, NLOS, conditions in a multipath channel of a vehicular communication system comprising at least a transmitting node and a receiving node which are configured to be in relative motion with respect to each other, the transmitting node being configured to transmit a plurality of non-periodic signals, the receiving node being configured to receive the plurality of non-periodic signals at a plurality of time points and comprises first and second antennas which are separated by a separation distance and configured to be mutually synchronized, the apparatus comprising:
a channel estimator for estimating, at each of the plurality of time points, first and second channel estimates respectively associated with each non-periodic signal received on the first and second antennas, each of the first and second channel estimates having multipath components arranged in clusters,
a channel processor for,
identifying a cluster of multipath components in each of the first and second channel estimates, wherein said identified cluster is received earlier in time than the remaining clusters,
generating a complex representation of each of the identified clusters comprising a complex amplitude component and one or more complex phase components, thereby generating first and second complex signals,
processing the first complex signal so as to remove phase components which are in common with phase components associated with the second complex signal, thereby creating a processed first complex signal,
a statistical hypothesis tester for applying a coherent generalized likelihood ratio test, GLRT, algorithm to the processed complex signals to identify LOS or NLOS conditions.

2. The apparatus of claim 1, wherein the channel processor is further configured for estimating a time of arrival of the clusters.

3. The apparatus of claim 1, wherein the channel processor is further configured for creating the processed first complex signal according to following relation,
x̅ᵣₓ₁=xᵣₓ₁×e^{-j×arg(x}^{ᵣₓ₂}⁾
where x̅ᵣₓ₁ is the processed first complex signal, xᵣₓ₁ is the first complex signal and xᵣₓ₂ is the second complex signal.

4. The apparatus of claim 1, wherein the channel processor is further configured for:
processing the second complex signal so as to remove phase components which are in common with phase components associated with the first complex signal, thereby creating a processed second complex signal, and
creating the processed second complex signal according to following relation,
x̅ᵣₓ₂=xᵣₓ₂×e^{-j×arg(x}^{ᵣₓ₁}⁾
where x̅ᵣₓ₂ is the processed second complex signal, xᵣₓ₁ is the first complex signal and xᵣₓ₂ is the second complex signal.

5. The apparatus of claim 1, wherein the channel processor is further configured for:
processing first and second complex signals so as to remove phase components which are in common in first and second complex signals, thereby creating a processed combined complex signal, and
creating the processed combined complex signal according to following relation,
x̅ᵣₓ=½×(xᵣₓ₁×e^{-j×arg(x}^{ᵣₓ₂}⁾+xᵣₓ₂*×e^{j×arg(x}^{ᵣₓ₁}⁾
where x̅ᵣₓ is the processed combined complex signal, xᵣₓ₁ is the first complex signal and xᵣₓ₂* is the complex conjugate of the second complex signal.

6. The apparatus of claim 1 wherein statistical hypothesis tester is further configured to determine the coherent GLRT algorithm according to following relation,
$$\frac{{\vert \frac{1}{N} \times {\sum }_{k = 0}^{N - 1} {x}_{k} \vert}^{2}}{\frac{1}{N} \times {\sum }_{k = 0}^{N - 1} {\vert {x}_{k} \vert}^{2}} \begin{matrix}{<}^{H 0} \\ {>}_{H 1}\end{matrix} σ$$
where N is the number of received non-periodic signals, xₖ is the processed complex signal, H0 is the NLOS hypothesis, H1 is the LOS hypothesis and σ is a predetermined threshold.

7. The apparatus of claim 6 wherein the statistical hypothesis tester comprises a memory for storing the processed complex signals wherein the memory is configured to discard a predetermined number of processed complex signals after the applying of the GLRT algorithm.

8. The apparatus of claim 1 further comprising a curve fitter for applying a curve fitting algorithm to the processed complex signals, thereby generating a best-fit curve defining a variation of the phase component of the processed complex signals over time,
wherein,
the channel processor being further configured for estimating phase compensated processed complex signals from the best-fit curve based on the plurality of time points, and
the statistical hypothesis test unit being further configured for applying the coherent GLRT to the phase compensated processed complex signals.

9. A method of identifying line of sight, LOS, and non-line of sight, NLOS, conditions in a multipath channel of a vehicular communication system comprising at least a transmitting node and a receiving node which are configured to be in relative motion with respect to each other, the transmitting node being configured to transmit a plurality of non-periodic signals, the receiving node being configured to receive the plurality of non-periodic signals at a plurality of time points and comprises first and second antennas which are separated by a separation distance and configured to be mutually synchronized, the method comprising:
estimating, at each of the plurality of time points, first and second channel estimates respectively associated with each non-periodic signal received on the first and second antennas, each of the first and second channel estimates having multipath components arranged in clusters,
identifying a cluster of multipath components in each of the first and second channel estimates, wherein said identified cluster is received earlier in time than the remaining clusters,
generating a complex representation of each of the identified clusters comprising a complex amplitude component and one or more complex phase components, thereby generating first and second complex signals,
processing the first complex signal so as to remove phase components which are in common with phase components associated with the second complex signal, thereby creating a processed first complex signal,
applying a coherent generalized likelihood ratio test, GLRT, algorithm to the processed complex signals to identify LOS or NLOS conditions.

10. The method of claim 9, wherein the identifying comprises estimating a time of arrival of the clusters.

11. The method of claim 9, wherein the processing comprises creating the processed first complex signal according to following relation,
x̅ᵣₓ₁=xᵣₓ₁×e^{-j×arg(x}^{ᵣₓ₂}⁾
where x̅ᵣₓ₁ is the processed first complex signal, xᵣₓ₁ is the first complex signal and xᵣₓ₂ is the second complex signal.

12. The method of claim 9, wherein the processing comprises:
processing the second complex signal so as to remove phase components which are in common with phase components associated with the first complex signal, thereby creating a processed second complex signal, and
creating the processed second complex signal according to following relation,
x̅ᵣₓ₂=xᵣₓ₂×e^{-j×arg(x}^{ᵣₓ₁}⁾
where x̅ᵣₓ₂ is the processed second complex signal, xᵣₓ₁ is the first complex signal and xᵣₓ₂ is the second complex signal.

13. The method of claim 9, wherein the processing comprises:
processing first and second complex signals so as to remove phase components which are in common in first and second complex signals, thereby creating a processed combined complex signal, and
creating the processed combined complex signal according to following relation,
x̅ᵣₓ=½×(xᵣₓ₁×e^{-j×arg(x}^{ᵣₓ₂}⁾+xᵣₓ₂*×e^{j×arg(x}^{ᵣₓ₁}⁾
where x̅ᵣₓ is the processed combined complex signal, xᵣₓ₁ is the first complex signal and xᵣₓ₂* is the complex conjugate of the second complex signal.

14. The method of claim 9 wherein the coherent GLRT algorithm is determined according to following relation,
$$\frac{{\vert \frac{1}{N} \times {\sum }_{k = 0}^{N - 1} {x}_{k} \vert}^{2}}{\frac{1}{N} \times {\sum }_{k = 0}^{N - 1} {\vert {x}_{k} \vert}^{2}} \begin{matrix}{<}^{H 0} \\ {>}_{H 1}\end{matrix} σ$$
where N is the number of received non-periodic signals, xₖ is the processed complex signal. H0 is the NLOS hypothesis, H1 is the LOS hypothesis and σ is a predetermined threshold.

15. The method of claim 14 further comprising discarding a predetermined number of processed complex signals after the applying of GLRT algorithm.

16. The method of claim 9 further comprising:
applying a curve fitting algorithm to the processed complex signals, thereby generating a best-fit curve defining a variation of the phase component of the processed complex signals over time,
estimating phase compensated processed complex signals from the best-fit curve based on the plurality of time points, and
applying the coherent GLRT to the phase compensated processed complex signals.
